(19) United States
(12) Patent Application Publication
(10) Pub. No.: US 2024/0360298 A1
(43) Pub. Date: Oct. 31, 2024

(54) COMPOSITIONS FOR MAKING BIODEGRADABLE PLASTIC

(71) Applicant: CTK RESEARCH AND DEVELOPMENT CANADA LTD., Surry (CA)

(72) Inventors: Zachary M. Hudson, Vancouver (CA); Emily D. Cranston, Vancouver (CA)

(73) Assignee: CTK RESEARCH AND DEVELOPMENT CANADA LTD., Surrey, BC (CA)

(21) Appl. No.: 18/686,550

(22) PCT Filed: Jan. 26, 2022
(86) PCT No.: PCT/CA2022/050108

§ 371 Date: Feb. 26, 2024

Related U.S. Application Data
(60) Provisional application No. 63/141,735, filed on Jan. 26, 2021.

(51) Int. Cl. C08L 3/02; B29C 48/00; B29C 48/16; B29C 48/40; B29C 48/78; B29K 29/00; B29K 509/10; B29K 511/00; C08K 3/34; C08K 5/053; C08K 5/103; C08K 11/00

(52) U.S. Cl. CPC C08L 3/02; B29C 48/022; B29C 48/16; B29C 48/40; B29C 48/78; C08K 3/346; C08K 5/053; C08K 5/103; C08K 11/005; B29K 2003/00; B29K 2029/04; B29K 2509/10; B29K 2511/00

(57) ABSTRACT

The present invention provides biodegradable compositions for making biodegradable plastic. The composition comprise about 25% to about 50% by weight starch; about 0.5% to about 10% by weight ground plant waste material; about 20% to about 50% a polymer derived from ethylene, vinyl alcohol and/or an ester of vinyl alcohol; about 10% to about 30% of a plasticizer; and about 3% to about 10% a filler and optionally a processing agent.

### FIELD OF THE INVENTION

The present invention pertains to the field of biodegradable polymeric material. In particular, it relates to compositions comprising starch useful in the formation of biodegradable materials.

### BACKGROUND OF THE INVENTION

Since their invention at the beginning of the 20th century, plastics have brought many social and technological benefits. For example, lightweight parts for cars and aircraft greatly reduce fuel consumption and cut CO₂ emissions, high-performance insulation reduces home heating costs, and is also used in clothing to keep us warm in cold climates, and countless medical innovations have been made using plastic instruments, saving human lives. Despite these many successes, the manner in which society produces, uses, and discards plastic materials has become a major environmental concern. 360 million tons of plastic are now produced each year, only 9% of which are recycled. The majority of these plastic materials are neither renewable nor biodegradable, and can persist in the environment for centuries or even millenia. Efforts to develop more sustainable options for plastic products have been ongoing.

Plastics made from bio-based sources have been developed, which are also referred to as ‘drop-in’ bio-based plastics because they can be substituted directly for fossil-based materials in the existing plastics supply chain. The most famous example of such a material is “Bio-PET” (Bio-Polyethylene terephthalate) made from 32% biomass and used in Coca-Cola's PlantBottle™. Similar alternatives for polyethylene (PE) and polypropylene (PP) have been developed. While these materials have some advantages, such as compatibility with the existing recycling infrastructures and reduced carbon footprint, these materials are no more biodegradable than petroleum derived PET, PP or PE.

Biodegrable plastics can be made from bio-based and/or petrochemical feedstocks. Five classes of materials currently make up >95% of the global supply of biodegradable plastics. Blends of starch alone account for 44% of this total, with poly(lactic acid) (aka PLA) being the second most common at 24%. An additional 23% of global supply is composed of petroleum-derived polyesters such as polybutylene adipate terephthalate (PBAT) and polybutylene succinate (PBS). While it is possible to produce the biodegradable plastics with partially bio-based feedstocks, commercial production of these plastics is still heavily reliant on fossil resources. Polyhydroxyalkanoates (PHAs) represent a relatively small share of the biodegradable plastics market, though this may grow as the costs of PHA production begin to fall.

Although better than synthetic plastics, the biodegradable plastics made from the above materials have their own challenges and disadvantages. For example, PLA is transparent (in the absence of additives), and can be used in applications where the consumer needs to be able to see the product. It is also relatively inexpensive compared to most commercially available bio-based, biodegradable polymers. PLA is relatively breathable, particularly as a thin film, making it well-suited to packaging foods that require oxygen such as salads. For this same reason, however, PLA should not be used to package materials that require a robust vapour or oxygen barrier (e.g. bread, crackers, coffee), as these materials can quickly go stale.

Polyglycolic Acid (PGA) is a biodegradable thermoplastic polymer that is chemically very similar to PLA. As a homopolymer, it is very brittle with high Young's modulus (7 GPa) and soluble in very few solvents, making it difficult to process. While PGA alone is of limited usefulness, copolymers of lactic and glycolic acid can be prepared that show properties intermediate between those of PLA and PGA.

Polyhydroxyalkanoates (PHAs) are a class of bio-based, biodegradable polymers produced by bacterial fermentation and found in nature in many kinds of microorganisms. They are capable of biodegradation under a much wider set of conditions compared with PLA. However, the bacterial fermentation process required for their production is time consuming and expensive, and makes their high cost of production has constrained their potential for growth.

PBAT is a petroleum-derived biodegradable thermoplastic composed of three components—terephthalic acid, adipic acid, and 1,4-butanediol. PBAT is one of the most important biodegradable polymers produced today, making up 11.6% of the global market. PBAT is industrially compostable, however, and not believed to biodegrade in unmanaged environments such as soil or seawater. In addition, PBAT is a costly material making substitution for PET difficult in many products.

PBS is a biodegradable thermoplastic made from the copolymerization of succinic acid and 1,4-butanediol. It is produced on a similar scale to PBAT, making up 11.4% of global biodegradable plastics production. PBS is also not considered biodegradable in unmanaged environments.

Starch based biodegradable materials have been developed due to the biodegradability and readily renewable nature of starch. Films of pure starch are brittle, absorb moisture, and do not behave as thermoplastics (they cannot be melt processed), and therefore processing of starch in the presence of additive(s) is required to make a thermoplastic product (i.e. thermoplastic starch, TPS). TPS has two major shortcomings as a packaging material: high water sensitivity and poor mechanical strength. Considerable research has been directed to overcoming these problems by blending starch with the right additives, such as plasticizers, natural fibers, nanoclay, or other biodegradable plastics. TPS is generally blended with polyvinyl alcohol (PVA), which is a petroleum-derived water-soluble thermoplastic polymer having good water solubility. When a product containing PVA is submerged in water, it may break down or dissolve, appearing to the eye as a sign of rapid degradation. In reality, the non-degraded polymer chains are simply dissolved in the water, where they may persist for long time. There are increasing environmental concerns about its release into wastewater, particularly at paper and textile mills.

Therefore there is a need for a biodegradable plastic material, which is biodegradable under managed and unmanaged environments (such as soil or seawater), compatible with traditional infrastructure for plastics manufacturing, cost effective, along with exhibiting desired physical and chemical properties, and long term stability.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide compositions for making biodegradable plastic.

In accordance with an aspect of the present invention, there is provided a composition comprising starch; ground plant waste material; a polymer derived from ethylene, vinyl alcohol and/or an ester of vinyl alcohol, and a plasticizer.

In accordance with an aspect of the present invention, there is provided a composition comprising: about 25% to about 50% by weight starch; about 0.5% to about 10% by weight ground plant waste material; about 20% to about 50% by weight a polymer derived from ethylene, vinyl alcohol, and/or an ester of vinyl alcohol; about 10% to about 30% of a plasticizer; and about 3% to about 10% by weight of a filler.

In accordance with an aspect of the present invention, there is provided a composition consisting of: about 25% to about 50% by weight starch; about 0.5% to about 10% by weight ground plant waste material; about 20% to about 50% by weight a polymer derived from ethylene, vinyl alcohol, and/or an ester of vinyl alcohol; about 10% to about 30% of a plasticizer; about 3% to about 10% by weight of a filler; 0 to about 3% by weight of a processing agent; and 0 to about 2% colorant.

In accordance with an aspect of the present invention, there is provided a composite material comprising a composition as described above and hereinafter, wherein the composition has undergone a heating process.

In accordance with an aspect of the present invention, there is provided a method of preparing a biodegradable plastic/composite material of the present invention. The method comprises mixing the components of the composition as described above and hereinafter, and heating the mixture at a processing temperature sufficient to melt the polymer.

### BRIEF DESCRIPTION OF THE FIGURES

Further features and advantages of the present disclosure will become apparent from the following detailed description, taken in combination with the appended drawings, in which:

FIG. 1 shows a Fourier Transformation infrared (FT-IR) spectroscopy spectrum of a plastic/composite material in accordance with the embodiments of the present invention.

FIGS. 2A, 2B and 2C depict exemplary products made by the biodegradable plastic/biocomposite material in accordance with the embodiments of the present invention.

FIG. 3 shows a Fourier Transformation infrared (FT-IR) spectroscopy spectrum of a plastic/composite material in accordance with the embodiments of the present invention.

FIG. 4 depicts an exemplary product made by the biodegradable plastic/biocomposite material in accordance with the embodiments of the present invention.

### DETAILED DESCRIPTION OF THE INVENTION

Unless defined otherwise, all technical and scientific terms used herein have the same meaning as commonly understood by one of ordinary skill in the art to which this invention belongs.

As used herein, the term “about” refers to a +/−10% variation from the nominal value. It is to be understood that such a variation is always included in a given value provided herein, whether or not it is specifically referred to.

As used herein, the term “plastic” refers to synthetic or semi-synthetic polymeric materials, for example composite material such as resins, that can undergo deformation under manufacturing techniques (such as such as extrusion, injection molding, blow molding, thermoforming, and compression molding, etc.) into a variety of shapes, such as: films, fibers, plates, tubes, bottles, boxes, etc., thereby making them an adaptable material for many different uses. Such polymeric materials when heated, do not undergo chemical change in their composition, and therefore can be molded repeatedly.

As used herein, the term “biodegradable plastic” refers to a plastic material that degrades or breaks down upon exposure to sunlight or ultra-violet radiation, water or dampness, microorganisms such as bacteria and fungi, enzymes or wind abrasion. In some instances, rodent, pest, or insect attack can also be considered as forms of biodegradation or environmental degradation.

As used herein, the term “bio-plastic” refers to plastic material produced using biomass feedstocks, which may or may not be biodegradable.

As used herein, the term “thermoplastic starch” (TP starch) refers to starch blended with suitable plasticizer(s).

As used herein, the phrase “managed environments” refer to biodegradation environments where waste material is intentionally broken down in a specific setting, and the environmental conditions are controlled to varying degrees. Examples of such managed environments are composting (such as home composting, windrow composting, in-vessel composting) and anaerobic digestions.

As used herein, the phrase “unmanaged environments” refer to the environment, where the conditions affecting the breakdown of the material are not managed at all. These “unmanaged environments” collectively include soil, seawater, and freshwater.

The present invention relates to novel compositions for making biodegradable plastic, the composition comprising starch; ground plant waste material; a polymer derived from ethylene, vinyl alcohol and/or an ester of vinyl alcohol; a plasticizer; and optionally a filler and/or a processing agent.

The plastic material made from the compositions of the present invention is degradable in managed and unmanaged environments, compatible with traditional infrastructure for plastics manufacturing, exhibit desired physical and chemical properties, and is suitable for production in a pelletized form. The desired physical properties of the plastic include stability up to 180° C., stability to humidity and oxygen, water solubility/water resistance, reduced or no environment damaging effect, and/or long shelf life.

Some compositions of the present invention can be used to form wrapping films that not only provide protection from potential damages during handling of products, yet can be discarded easily.

In some embodiments, the composition of the present invention comprises about 5 to about 60% by weight of the composition of starch, about 0.5 to about 30% by weight of the composition of ground plant waste material; about 5 to about 50% of the composition of a polymer derived from ethylene, vinyl alcohol or an ester thereof, about 2% to about 30% of a plasticizer, and optionally about 2% to about 10% of a filler and/or optionally about 0.5 to about 3% of a processing agent.

In some embodiments, the composition comprises:
about 25% to about 50% by weight starch;
about 0.5% to about 10% by weight ground plant waste material;
about 20% to about 50% by weight a polymer derived from ethylene, vinyl alcohol, and/or an ester of vinyl alcohol;
about 10% to about 30% of a plasticizer; and
about 3% to about 10% by weight of a filler.

The “plant waste material” suitable for the composition of the present invention is waste material from plants comprising cellulosic material, such as hemp stalk, chaff and/or stem of rice plant, chaff and/or stem of wheat plant, corn straw, flax, hemp, sisal, cotton, etc. The phrase “plant waste material” as used herein also includes coffee grounds.

The ground plant waste material suitable for use in the present composition can be obtained by chopping, crushing, mincing, pulverizing, grating and/or pounding.

In some embodiments, the ground plant waste material is in powder form or dust form.

In some embodiments, the ground plant waste material is powdered hemp stalk, wherein hemp hurd and/or bast fibers are ground, milled and/or sliced into micron size particles. The powder can be in the form of dust.

In some embodiments, the hemp powder is composed of the hemp core and bast fibers. In some embodiments, the hemp powder is primarily composed of the hemp core and residual bast fibers. In some embodiments, the hemp powder is composed of hemp hurd.

In some embodiments, the hemp powder comprises particles having length about 75 to 150 μm, width about 15 to 40 μm, and an aspect ratio of about 3.5 to 5. In some embodiments, the hemp powder has density about 1.0 to 2.0 g/cm³.

In some embodiments, the hemp powder comprises about 60-75% cellulose, about 5-15% hemicellulose and about 10-25% lignin.

In some embodiments, the hemp powdered is treated to remove tetrahydrocannabinol (THC) & cannabidiol (CBD) therefrom.

In some embodiments, the hemp stalk is washed with about 2-10% solution of sodium hydroxide in water (1 part stalk and/or fiber per 10 parts solution by weight), and then dried.

The starch can be any plant starch (root and/grain starch), such as potato starch, sweet potato starch, corn starch, bracken starch, wheat starch, cassava starch, sago palm starch, rice starch, tapioca starch, soybean starch, arrow root starch, lotus starch, buckwheat starch or any mixture thereof.

In some embodiments, the starch is in powder form.

In some embodiments, starch is unprocessed (i.e. in a natural state thereof), wherein the starch has not been modified by chemical or any other means. In some embodiments, the starch is modified starch, such as “thermoplastic starch” (i.e. starch blended with suitable plasticizer(s)).

In some embodiments, the starch used in the present composition is high in amylose content, such as 25-35% amylose content and/or 65-75% amylopectin content.

In some embodiments, the starch is a commercial amylose powder, or a mixture thereof with starch.

In some embodiments, the starch may have a moisture content about 10% to 20% by weight of the starch.

The polymer within the composition can be a homopolymer or a copolymer.

In some embodiments, the polymer is derived from vinyl alcohol and/or C₁-C₆ ester of vinyl alcohol (such as vinyl acetate).

In some embodiments, the polymer is poly(vinyl alcohol) (PVA). In some embodiments, the PVA has degree of hydrolysis (DHA) of about 80-99%. In some embodiments, the PVA has a viscosity of 15-30 centipoise. In some embodiments, the viscosity is about 20-25 centipoise.

In some embodiments, the polymer is poly (vinyl acetate). In some embodiments, the polymer is polyethylene.

Non-limiting examples of suitable plasticizers include polyols (such as glycerol), ethylene glycol, polyglycerol, sorbitol, sucrose, fructose, glucose, urea, and any mixture thereof. In some embodiments, the plasticizer is glycerol.

Non-limiting examples of processing agents include fatty acids such as stearic acid, erucic acid, palmitic acid, etc., and esters of fatty acids such as glycerol monostearate. In some embodiments, the processing agent is glycerol monostearate.

Suitable fillers for the composition of the present invention include talc, clay, wollastonite, carbonate, bicarbonate, oxide or sulfate of alkali metal or alkali earth metal or nanoclay. Nanoclays are nanoscale particles of layered silicate minerals which have extremely high surface areas—a single gram of nanoclay can have a surface area of 600-800 m2. Non-limiting examples of nanoclays are montmorillonite (MMT), perlite, sepiolite, and kaolinite. In some embodiments, the filler is MMT.

In some embodiments, the composition further comprises about 0.5-2% a colorant, such as a pigment, mineral and/or dye. In some embodiments, the composition comprises about 1% colorant. In some embodiments, the colorant is titanium dioxide.

In some embodiments, the composition further comprises a wax comprising one or more ester of fatty acid with alcohol. In some embodiments, the wax comprising one or more ester of C6-C18 carboxylic acid with C15-C32 alcohol. In some embodiments, the wax is an ester of palmitic acid. In some embodiments, the wax is naturally occurring wax, such as beeswax. The wax can be about 1% to about 5% of the composition.

In one embodiment, the composition consists of:
about 25% to about 50% by weight starch;
about 0.5% to about 10% by weight ground plant waste material;
about 20% to about 50% by weight a polymer derived from ethylene, vinyl alcohol, and/or an ester of vinyl alcohol;
about 10% to about 30% of a plasticizer;
about 3% to about 10% by weight of a filler;
0 to about 3% by weight of a processing agent; and
0 to about 2% colorant.

In another aspect, the present invention provides a biodegradable plastic/composite material made from the compositions as described above. Such composite material can be obtained by subjecting the compositions of the present invention to a heating process.

In another aspect, the present invention provides a method of preparing a biodegradable plastic/composite material of the present invention. The method comprises mixing the components of the composition as described above and extruding the mixture at a processing temperature sufficient to melt the polymer. The mixing of the components can include batch mixing and/or continuous mixing.

In some embodiments, the mixture is extruded via a screw extruder with a screw speed of about 100 to about 200 rpm. In some embodiments, the processing temperature is about 150° C. to about 200° C.

In some embodiments, the vinyl polymer is poly(vinyl alcohol) (PVA) and the processing temperature is about 150° C. to about 200° C., preferably about 160° C. to about 175° C.

In some embodiments, the biodegradable plastic/composite material of the present invention can comprise:
about 25% to about 50% by weight starch;
about 0.5% to about 10% by weight ground plant waste material;
about 20% to about 50% by weight a polymer derived from ethylene, vinyl alcohol, and/or an ester of vinyl alcohol;
about 10% to about 30% of a plasticizer; and
about 3% to about 10% by weight of a filler.

In some embodiments, the biodegradable plastic/composite material of the present invention can comprise:
about 25% to about 50% by weight starch;
about 0.5% to about 10% by weight ground plant waste material;
about 20% to about 50% by weight a polymer derived from ethylene, vinyl alcohol, and/or an ester of vinyl alcohol;
about 10% to about 30% of a plasticizer;
about 3% to about 10% by weight of a filler;
0 to about 3% by weight of a processing agent; and
0 to about 2% colorant.

The plastic/composite material of the present invention can have a melt flow index (MFI) of about 2 to about 10 at o near the melting temperature thereof, and can undergo deformation under manufacturing techniques, such as extrusion, injection molding, blow molding, thermoforming, and compression molding, etc.

In some embodiments, the plastic/composite material of the present invention can be used for injection molding and compression molding to form semi-soft or hard solid products of different shapes, and thick films.

To gain a better understanding of the invention described herein, the following examples are set forth with reference to the accompanying drawings. It will be understood that these examples are intended to describe illustrative embodiments of the invention and are not intended to limit the scope of the invention in any way.

### Examples

### Example 1: Preparation of Biodegradable, Soft Composite Resin

A biodegradable composite material was obtained by extruding a specific composition comprising:
about 37% by weight starch;
about 25% by weight glycerol;
about 1% powdered hemp stalk;
about 30% polyvinyl alcohol (PVA);
about 2% by weight glycerol monostearate (GMS);
about 5% by weight montmorillonite (MMT)

The extrusion of the composition was conducted using a 27 mm Leistriz twin screw extruder with the following temperature profile in nine-heating zones: 175, 175, 175, 175, 175, 175, 170, 165 and 160° C. The feeding rate was kept constant at 1 kg/h and a screw speed of 150 RPM was used.

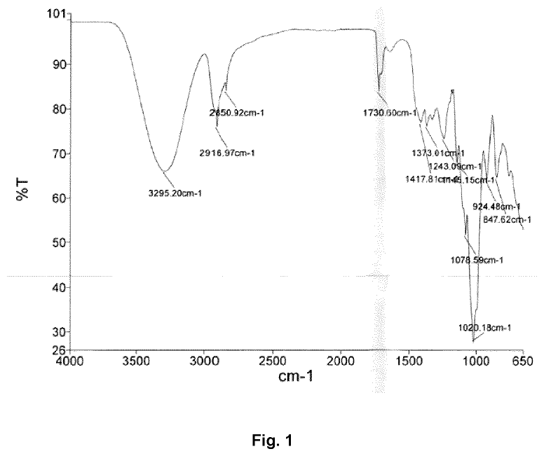

Analysis of the composite material by Fourier Transformation infrared spectroscopy (FT-IR), reveals a broad peak around 3300 cm-1, indicating the presence of PVA in the material (FIG. 1). This signal corresponds to the stretching of alcohol functional groups as well as hydrogen bonding.

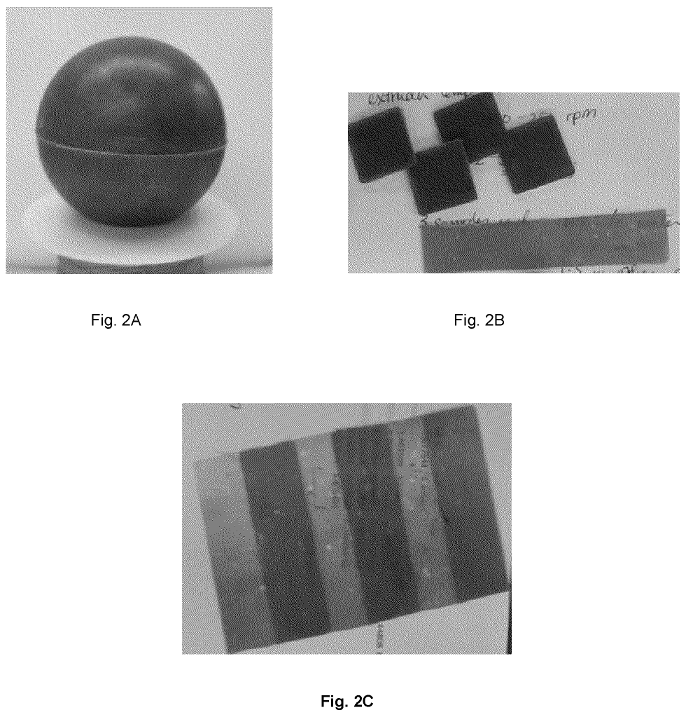

Extrusion product was found to have a melt flow index (MFI) of 3 at 190° C. (2.16 kg). It can be used for injection molding and compression molding to form semi-soft containers with different shapes as well as thick films (FIGS. 2A, 2B and 2C). Samples made by compression molding were made at 180° C. and 10 tons of pressure. Due to the presence of granulated/powdered hemp material, films were thick (over 100 microns).

### Example 2: Preparation of Biodegradable, Hard Composite Resin

A biodegradable composite material was obtained by extruding a specific composition comprising:
about 35% by weight starch;
about 26% by weight glycerol;
about 5% powdered hemp stalk;
about 25% polyvinyl alcohol (PVA);
about 2% by weight glycerol monostearate (GMS);
about 6% by weight montmorillonite (MMT);
about 1% by weight TiO₂ as pigment.

The extrusion of the composition was conducted using a 27 mm Leistriz twin screw extruder with the following temperature profile in nine-heating zones: 170, 170, 170, 170, 170, 170, 170, 170, 170° C. The feeding rate was kept constant at 1 kg/h and a screw speed of 150 RPM was used.

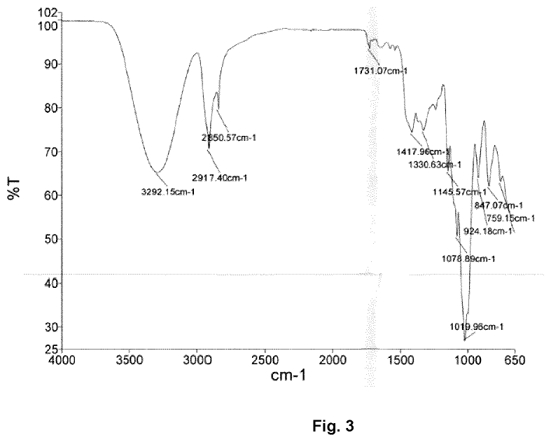

Similarly to the previous example, analysis of the composite material by FT-IR spectroscopy reveals a broad peak around 3300 cm-1, indicating the presence of PVA as the main component in the material (FIG. 3).

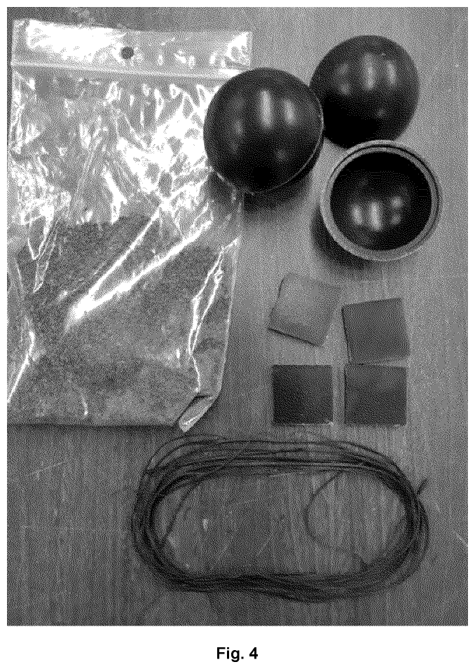

Extrusion product was found to have a melt flow index (MFI) of 7 at 190° C. (2.16 kg). It can be used for injection molding to form hard solid containers (FIG. 4).

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A composition for making biodegradable plastic, the composition comprising:
about 25% to about 50% by weight starch;
about 0.5% to about 10% by weight ground plant waste material;
about 20% to about 50% by weight a polymer derived from ethylene, vinyl alcohol, and/or an ester of vinyl alcohol;
about 10% to about 30% of a plasticizer; and
about 3% to about 10% by weight of a filler.

2. The composition of claim 1 wherein the plasticizer is selected from glycerol, ethylene glycol, sorbitol, sucrose, fructose, glucose, and urea.

3. The composition of claim 1, wherein the filler is selected from montmorillonite (MMT), perlite, sepiolite, and kaolinite.

4. The composition of claim 1, further comprising about 0.5% to about 3% by weight of a processing agent selected from glycerol monostearate, erucic acid, palmitic acid, and stearic acid.

5. The composition of claim 1, further comprising about 0.5% to about 2% by weight of a colorant.

6. A composition for making biodegradable plastic, the composition consisting of:
about 25% to about 50% by weight starch;
about 0.5% to about 10% by weight ground plant waste material;
about 20% to about 50% by weight a polymer derived from ethylene, vinyl alcohol, and/or an ester of vinyl alcohol;
about 10% to about 30% of a plasticizer;
about 3% to about 10% by weight of a filler;
0 to about 3% by weight of a processing agent; and
0 to about 2% a colorant.

7. The composition of claim 1, wherein the ground plant waste material is powdered hemp stalk, optionally the powdered hemp stalk has been treated to remove THC & CBD therefrom.

8. (canceled)

9. The composition of claim 1, wherein the vinyl polymer is poly(vinyl alcohol) (PVA).

10. The composition of claim 9, wherein the PVA has a degree of hydrolysis of about 80-99% and/or a viscosity of 15-30 centipoise.

11. (canceled)

12. The composition of claim 1, wherein the vinyl polymer is poly(vinyl acetate).

13. The composition of claim 1, wherein the starch has amylose content about 25-30%.

14. A biodegradable composite material comprising a composition as defined in claim 1, wherein the composition has undergone a heating process.

15. A method of preparing a composite material, the method comprising:
a) mixing about 25% to about 50% by weight starch;
about 0.5% to about 10% by weight ground plant waste material;
about 20% to about 50% by weight a polymer derived from ethylene, vinyl alcohol, and/or an ester of vinyl alcohol;
about 10% to about 30% of a plasticizer;
about 3% to about 10% by weight of a filler;
0 to about 3% by weight of a processing agent; and
0 to about 2% colorant; and
b) heating said mixture at a processing temperature sufficient to melt the polymer.

16. The method of claim 15, wherein the mixture is extruded via a screw extruder with a screw speed of about 100 to about 200 rpm.

17. The method of claim 15, wherein the vinyl polymer is poly(vinyl alcohol) (PVA) and the processing temperature is about 150° C. to about 200° C.

18. The method of claim 15, wherein the vinyl polymer is poly(vinyl alcohol) (PVA) and the processing temperature is about 160° C. to about 175° C.

19. The composition of claim 6, wherein the ground plant waste material is powdered hemp stalk, optionally the powdered hemp stalk has been treated to remove THC & CBD therefrom.

20. The composition of claim 6 wherein the plasticizer is selected from glycerol, ethylene glycol, sorbitol, sucrose, fructose, glucose, and urea.

21. The composition of claim 6, wherein the filler is selected from montmorillonite (MMT), perlite, sepiolite, and kaolinite.

22. The composition of claim 6, wherein the processing agent selected from glycerol monostearate, erucic acid, palmitic acid, and stearic acid.

23. The composition claim 6, wherein the vinyl polymer is poly(vinyl alcohol) (PVA).

24. The composition of claim 23, wherein the PVA has a degree of hydrolysis of about 80-99%.

25. The composition of claim 24, wherein the PVA has a viscosity of 15-30 centipoise wherein the PVA has a degree of hydrolysis of about 80-99% and/or a viscosity of 15-30 centipoise.

26. The composition of claim 6, wherein the vinyl polymer is poly(vinyl acetate).
